(19) United States
(12) Patent Application Publication
(10) Pub. No.: US 2025/0133513 A1
(43) Pub. Date: Apr. 24, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jianfei CAO, Dongguan (CN); Xin YOU, Dongguan (CN); Wenhong CHEN, Dongguan (CN)

(21) Appl. No.: 19/000,960

(22) Filed: Dec. 24, 2024

Related U.S. Application Data
(63) Continuation of application No. PCT/CN2022/107527, filed on Jul. 22, 2022.

(51) Int. Cl. H04W 56/00

(52) U.S. Cl. CPC H04W 56/0005

(57) ABSTRACT

A wireless communication method, a terminal device, and a network device are provided. The method includes: when a terminal device is being in uplink synchronization with a first TRP, determining, by the terminal device, uplink synchronization information for a second TRP, where the uplink synchronization information for the second TRP is determined based on one or more of following information: uplink synchronization information for the first TRP; a downlink time difference of arrival, where the downlink time difference of arrival is used for indicating a difference between a time at which a signal of the first TRP arrives at the terminal device and a time at which a signal of the second TRP arrives at the terminal device; or a transmission timing difference between the first TRP and the second TRP.

### CROSS-REFERENCE TO RELATED APPLICATIONS

This application is a continuation of International Application No. PCT/CN2022/107527, filed on Jul. 22, 2022, the disclosure of which is hereby incorporated by reference in its entirety.

### TECHNICAL FIELD

This application relates to the field of communications technologies, and more specifically, to a wireless communication method, a terminal device, and a network device.

### BACKGROUND

In some communications systems, uplink synchronization information (for example, timing advance (TA)) between a terminal device and a transmission-reception point (TRP) may be determined by using a TRP as a granularity. In this case, the terminal device may access a TRP by initiating a random access procedure to obtain the uplink synchronization information for the TRP. A manner in which the terminal device obtains uplink synchronization information for a TRP by using the random access procedure is not flexible, which may cause high uplink resource overheads and a lengthy transmission delay.

### SUMMARY

This application provides a wireless communication method, a terminal device, and a network device. The following describes the aspects involved in this application.

According to a first aspect, a wireless communication method is provided, and the method includes: when a terminal device is being in uplink synchronization with a first transmission-reception point TRP, determining, by the terminal device, uplink synchronization information for a second TRP. The uplink synchronization information for the second TRP is determined based on one or more of the following information: uplink synchronization information for the first TRP; a downlink time difference of arrival, where the downlink time difference of arrival is used for indicating a difference between a time at which a signal of the first TRP arrives at the terminal device and a time at which a signal of the second TRP arrives at the terminal device; or a transmission timing difference between the first TRP and the second TRP.

According to a second aspect, a wireless communication method is provided, and the method includes: when a terminal device is being in uplink synchronization with a first transmission-reception point TRP, receiving, by the terminal device, first information, where the first information is used for activating a second TRP located in a different cell from the first TRP; and in response to the first information, transmitting, by the terminal device, an uplink reference signal to the second TRP, where the uplink reference signal is used by a network device to determine uplink synchronization information for the second TRP.

According to a third aspect, a wireless communication method is provided, and the method includes: when a terminal device is being in uplink synchronization with a first transmission-reception point TRP, determining, by a network device, uplink synchronization information for a second TRP. The uplink synchronization information for the second TRP is determined based on one or more of the following information: uplink synchronization information for the first TRP; a downlink time difference of arrival, where the downlink time difference of arrival is used for indicating a difference between a time at which a signal of the first TRP arrives at the terminal device and a time at which a signal of the second TRP arrives at the terminal device; or a transmission timing difference between the first TRP and the second TRP.

According to a fourth aspect, a wireless communication method is provided, and the method includes: when a terminal device is being in uplink synchronization with a first transmission-reception point TRP, transmitting, by a network device, first information to the terminal device, where the first information is used for activating a second TRP located in a different cell from the first TRP; and determining, by the network device, uplink synchronization information for the second TRP, where the uplink synchronization information is determined based on an uplink reference signal transmitted by the terminal device to the second TRP.

In a fifth aspect, a terminal device is provided and includes: a determining module, configured to: when the terminal device is being in uplink synchronization with a first transmission-reception point TRP, determine uplink synchronization information for a second TRP. The uplink synchronization information for the second TRP is determined based on one or more of the following information: uplink synchronization information for the first TRP; a downlink time difference of arrival, where the downlink time difference of arrival is used for indicating a difference between a time at which a signal of the first TRP arrives at the terminal device and a time at which a signal of the second TRP arrives at the terminal device; or a transmission timing difference between the first TRP and the second TRP.

In a sixth aspect, a terminal device is provided and includes: a receiving module, configured to: when the terminal device is being in uplink synchronization with a first transmission-reception point TRP, receive first information, where the first information is used for activating a second TRP located in a different cell from the first TRP; and a transmitting module, configured to: in response to the first information, transmit an uplink reference signal to the second TRP, where the uplink reference signal is used by a network device to determine uplink synchronization information for the second TRP.

According to a seventh aspect, a network device is provided and includes: a determining module, configured to: when the terminal device is being in uplink synchronization with a first transmission-reception point TRP, determine uplink synchronization information for a second TRP. The uplink synchronization information for the second TRP is determined based on one or more of the following information: uplink synchronization information for the first TRP; a downlink time difference of arrival, where the downlink time difference of arrival is used for indicating a difference between a time at which a signal of the first TRP arrives at the terminal device and a time at which a signal of the second TRP arrives at the terminal device; or a transmission timing difference between the first TRP and the second TRP.

According to an eighth aspect, a network device is provided and includes: a transmitting module, configured to: when a terminal device is being in uplink synchronization with a first transmission-reception point TRP, transmit first information to the terminal device, where the first information is used for activating a second TRP located in a different cell from the first TRP; and a determining module, configured to determine uplink synchronization information for the second TRP, where the uplink synchronization information is determined based on an uplink reference signal transmitted by the terminal device to the second TRP.

According to a ninth aspect, a terminal device is provided, including a processor, a memory, and a communications interface, where the memory is configured to store one or more computer programs, and the processor is configured to invoke the computer program in the memory so that the terminal device performs some or all of the steps in the method in the first aspect or the second aspect.

According to a tenth aspect, a network device is provided and includes a processor, a memory, and a communications interface. The memory is configured to store one or more computer programs, and the processor is configured to invoke the computer program in the memory to cause the network device to perform some or all of the steps of the method according to the third aspect or the fourth aspect.

According to an eleventh aspect, an embodiment of this application provides a communications system, where the system includes the terminal device and/or the network device described above. In another possible design, the system may further include another device that interacts with the terminal device or the network device in the solutions provided in embodiments of this application.

According to a twelfth aspect, an embodiment of this application provides a computer-readable storage medium. The computer-readable storage medium stores a computer program, and the computer program causes a terminal device or a network device to perform some or all of the steps in the method according to the foregoing aspects.

According to a thirteenth aspect, an embodiment of this application provides a computer program product. The computer program product includes a non-transitory computer-readable storage medium that stores a computer program, and the computer program is operable to cause a terminal device or a network device to perform some or all of the steps in the method according to the foregoing aspects. In some implementations, the computer program product may be a software installation package.

According to a fourteenth aspect, an embodiment of this application provides a chip, where the chip includes a memory and a processor, and the processor may invoke a computer program from the memory and run the computer program, to implement some or all of the steps in the methods according to the foregoing aspects.

A terminal device, while being in uplink synchronization with a first TRP determines uplink synchronization information for a second TRP with the first TRP as a reference and taking one or more of the following information into consideration: uplink synchronization information for the first TRP, a downlink time difference of arrival, and a transmission timing difference between the first TRP and the second TRP. Based on this, the terminal device can obtain the uplink synchronization information for the second TRP without initiating a random access procedure to the second TRP, thereby helping to reduce uplink resource overheads and a transmission delay.

### BRIEF DESCRIPTION OF DRAWINGS

FIG. 1A to FIG. 1C are system architectural diagrams of communications systems to which an embodiment of this application is applicable.

FIG. 2 is an example diagram of a relationship between an uplink frame and a downlink frame in a TA scenario.

FIG. 3 is an example diagram of a format of a MAC CE that carries a TAC.

FIG. 4 is another example diagram of a format of a MAC CE that carries a TAC.

FIG. 5 is an example diagram of a format of a MAC RAR that carries a TAC.

FIG. 6 is a schematic flowchart of a four-step random access procedure.

FIG. 7 is an example diagram of a multi-TRP scenario to which an embodiment of this application is applicable.

FIG. 8 is a schematic flowchart of a wireless communication method according to an embodiment of this application.

FIG. 9 is an example diagram of determining uplink synchronization information for a second TRP according to an embodiment of this application.

FIG. 10 is an example diagram of determining uplink synchronization information for a second TRP according to another embodiment of this application.

FIG. 11 is a schematic flowchart of a wireless communication method according to another embodiment of this application.

FIG. 12 is an example diagram of a format of a MAC CE indicating a transmission timing difference according to an embodiment of this application.

FIG. 13 is an example diagram of a format of a MAC CE indicating a transmission timing difference according to another embodiment of this application.

FIG. 14 is an example diagram of a format of a MAC CE indicating a transmission timing difference according to still another embodiment of this application.

FIG. 15 is an example diagram of a format of a MAC CE indicating a transmission timing difference according to still another embodiment of this application.

FIG. 16 is a schematic flowchart of a wireless communication method according to still another embodiment of this application.

FIG. 17 is a schematic flowchart of a wireless communication method according to still another embodiment of this application.

FIG. 18 is a schematic flowchart of a wireless communication method according to still another embodiment of this application.

FIG. 19 is a schematic structural diagram of a terminal device according to an embodiment of this application.

FIG. 20 is a schematic structural diagram of a terminal device according to another embodiment of this application.

FIG. 21 is a schematic structural diagram of a network device according to an embodiment of this application.

FIG. 22 is a schematic structural diagram of a network device according to another embodiment of this application.

FIG. 23 is a schematic structural diagram of a communications apparatus according to an embodiment of this application.

### DESCRIPTION OF EMBODIMENTS

### Communications System Architecture

The technical solutions in embodiments of this application may be applied to various communications systems, for example, a global system for mobile communications (GSM), a code-division multiple access (CDMA) system, a wideband code-division multiple access (WCDMA) system, general packet radio service (GPRS), a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial networks (NTN) system, a universal mobile telecommunications system (UMTS), a wireless local area network (WLAN), wireless fidelity (WiFi), a fifth-generation (5G) system, or another communications system, for example, a future communications system such as a sixth-generation mobile communications system or a satellite communications system.

Generally, a quantity of connections supported by a conventional communications system is limited, and is also easy to implement. However, with development of communication technologies, a mobile communications system not only supports conventional communication, but also supports, for example, device-to-device (D2D) communication, machine-to-machine (M2M) communication, machine type communication (MTC), vehicle-to-vehicle (V2V) communication, or vehicle to everything (V2X) communication. Embodiments of this application may also be applied to these communications systems.

The communications system in embodiments of this application may be applied to a carrier aggregation (CA) scenario, a dual connectivity (DC) scenario, or a standalone (SA) networking scenario.

The communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a dedicated spectrum.

Embodiments of this application may be applied to an NTN system, or may be applied to a terrestrial communication network (TN) system. By way of example and without limitation, the NTN system includes an NR-based NTN system and an IoT-based NTN system.

Embodiments of this application are described with reference to a network device and a terminal device. The terminal device may also be referred to as a user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, a user apparatus or the like.

In embodiments of this application, the terminal device may be a STATION (ST) in a WLAN, or may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, an in-vehicle device, a wearable device, a next-generation communications system such as a terminal device in a NR network, or a terminal device in a future evolved public land mobile network (PLMN) network.

In embodiments of this application, the terminal device may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (virtual reality, VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the terminal device may function as a base station. For example, the terminal device may function as a scheduling entity, which provides a sidelink signal between terminal devices in V2X, D2D, or the like. For example, a cellular phone and a vehicle communicate with each other by using a sidelink signal. A cellular phone and a smart home device communicate with each other, without relay of a communication signal through a base station.

By way of example and without limitation, in embodiments of this application, the terminal device may also be a wearable device. The wearable device may also be referred to as a wearable smart device, and is a general term for wearable devices such as glasses, gloves, watches, clothes, and shoes that are intelligently designed and developed by applying wearable technologies to daily wearing. The wearable device is a portable device that is directly worn on a body or integrated into clothes or an accessory of a user. In addition to being a hardware device, the wearable device can also implement various functions through software support, data exchange, and cloud interaction. In a broad sense, the wearable smart device includes a full-featured and large-sized device that can implement all or some functions without relying on a smartphone, for example, a smart watch or smart glasses, and a device that only focuses on a specific type of application function and needs to be used in cooperation with another device such as a smartphone, for example, various smart bracelets and smart jewelries for physical sign monitoring.

The network device in embodiments of this application may be a device configured to communicate with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names in the following, or may be replaced with the following names: a NodeB, an evolved NodeB (eNB), a next generation NodeB (gNB), a relay station, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, vehicle-to-everything (V2X), and machine-to-machine (M2M) communication, a network-side device in a 6G network, a device that functions as a base station in a future communications system, or the like. The base station may support networks with a same access technology or different access technologies. A specific technology and specific device form used by the network device are not limited in embodiments of this application.

The base station may be a stationary or mobile station. For example, a helicopter or an unmanned aerial vehicle may be configured to serve as a mobile base station, and one or more cells may move according to a location of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, indoors or outdoors, and may be handheld, wearable, or vehicle-mounted; may be deployed on water (for example, on a ship); or may be deployed in the sky (for example, on an airplane, an air balloon, or a satellite). In embodiments of this application, a scenario of the network device and the terminal device is not limited.

By way of example and without limitation, in embodiments of this application, the network device may have a mobility characteristic. For example, the network device may be a mobile device. In some embodiments of this application, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of this application, the network device may alternatively be a base station located on land, water, or the like.

In the embodiments of this application, the network device may provide a service for a cell, and the terminal device communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell. The small cell herein may include a metro cell, a micro cell, a pico cell, a femto cell, or the like. These small cells feature small coverage and low transmit power, and are suitable for providing a high-speed data transmission service.

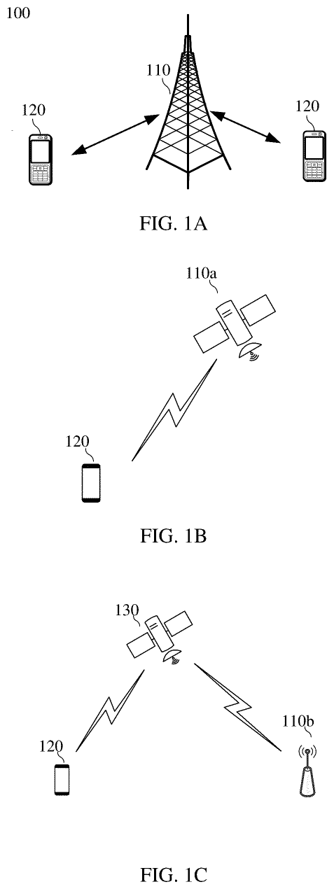

Exemplarily, FIG. 1A is a schematic diagram of an architecture of a communications system according to an embodiment of this application. As shown in FIG. 1A, the communications system 100 may include a network device 110, and the network device 110 may be a device that communicates with a terminal device 120 (or referred to as a communications terminal or a terminal). The network device 110 may provide communication coverage for a specific geographical region, and may communicate with a terminal device within the coverage.

FIG. 1A exemplarily shows one network device and two terminal devices. In some embodiments of this application, the communications system 100 may include a plurality of network devices, and another quantity of terminal devices may be included within a coverage range of each network device, which is not limited in embodiments of this application.

Exemplarily, FIG. 1B is a schematic diagram of an architecture of another communications system according to an embodiment of this application. Referring to FIG. 1B, the communications system includes a terminal device 120 and a satellite 110a, and wireless communication may be performed between the terminal device 120 and the satellite 110a. A network formed between the terminal device 120 and the satellite 110a may also be referred to as an NTN. In the architecture of the communications system shown in FIG. 1B, the satellite 110a may have a function of a base station, and direct communication may be performed between the terminal device 120 and the satellite 110a. In the communications system architecture, the satellite 110a may be referred to as a network device. In some embodiments, the communications system may include a plurality of network devices 110a, and another quantity of terminal devices may be included within a coverage range of each network device 110a, which is not limited in embodiments of this application.

Exemplarily, FIG. 1C is a schematic diagram of an architecture of another communications system according to an embodiment of this application. Referring to FIG. 1C, the communications system includes a terminal device 120, a satellite 130, and a base station 110b. Wireless communication may be performed between the terminal device 120 and the satellite 130, and communication may be performed between the satellite 130 and the base station 110b. A network formed between the terminal device 120, the satellite 130, and the base station 110b may also be referred to as an NTN. In the architecture of the communications system shown in FIG. 1C, the satellite 130 may not have a function of a base station, and communication between the terminal device 120 and the base station 110b needs to be forwarded by the satellite 130. Under this system architecture, the base station 110b may be referred to as a network device. In some embodiments of this application, the communications system may include a plurality of network devices 110b, and another quantity of terminal devices may be included within a coverage range of each network device 110b, which is not limited in embodiments of this application.

It should be noted that FIG. 1A to FIG. 1C are merely examples of a system to which this application applies. Certainly, the methods shown in embodiments of this application may also be applied to another system, such as a 5G communications system or an LTE communications system. This is not specifically limited in embodiments of this application.

In some embodiments of this application, the wireless communications systems shown in FIG. 1A to FIG. 1C may further include another network entity such as a mobility management entity (MME) or an access and mobility management function (AMF), which is not limited in embodiments of this application.

It should be understood that a device having a communication function in a network or a system in embodiments of this application may be referred to as a communications device. The communications system 100 shown in FIG. 1A is used as an example. The communications device may include the network device 110 and the terminal device 120 that have a communication function. The network device 110 and the terminal device 120 may be specific devices described above, and details are not described herein again. The communications device may further include another device in the communications system 100, for example, another network entity such as a network controller or a mobility management entity, which is not limited in embodiments of this application.

It should be understood that, an “indication” mentioned in embodiments of this application may be a direct indication or an indirect indication, or may indicate the presence of an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In description of embodiments of this application, the term “corresponding” may mean that there is a direct or indirect correspondence between the two, or may mean that there is an association relationship between the two, or may mean that there is a relationship such as indicating and being indicated, or configuring and being configured.

“configuration” in embodiments of this application may include configuration performed by using at least one of a system message, radio resource control (RRC) signalling, or a medium access control control element (MAC CE).

In some embodiments of this application, “predefined” or “preset” may be implemented by pre-storing a corresponding code or table in a device (for example, the terminal device and the network device) or in another manner that may be used for indicating related information, and a specific implementation thereof is not limited in this application. For example, being predefined may refer to being defined in a protocol.

In some embodiments of this application, the “protocol or standard” may refer to a standard protocol in the communications field, and may include, for example, an LTE protocol, an NR protocol, and a related protocol applied to a future communications system, which is not limited in this application.

For ease of understanding, some related technical knowledge related to the embodiments of this application is first introduced. The following related technologies, as optional solutions, may be randomly combined with the technical solutions of the embodiments of this application, all of which fall within the protection scope of the embodiments of this application. The embodiments of this application include at least part of the following content.

### Uplink Synchronization

Uplink synchronization refers to a process in which uplink signals from terminal devices that are in different locations of a serving cell and that use a same slot simultaneously arrive at a receiving antenna of a network device, that is, signals from different terminal devices arrive at the receiving antenna of the network device synchronously at a same slot. The purpose of uplink synchronization is to reduce uplink multiple-access interference and multi-path interference between terminal devices in a serving cell.

In an uplink synchronization process, a terminal device may perform uplink synchronization with a network device based on uplink synchronization information corresponding to the network device. For example, the uplink synchronization information may include TA.

### Timing Advance (TA)

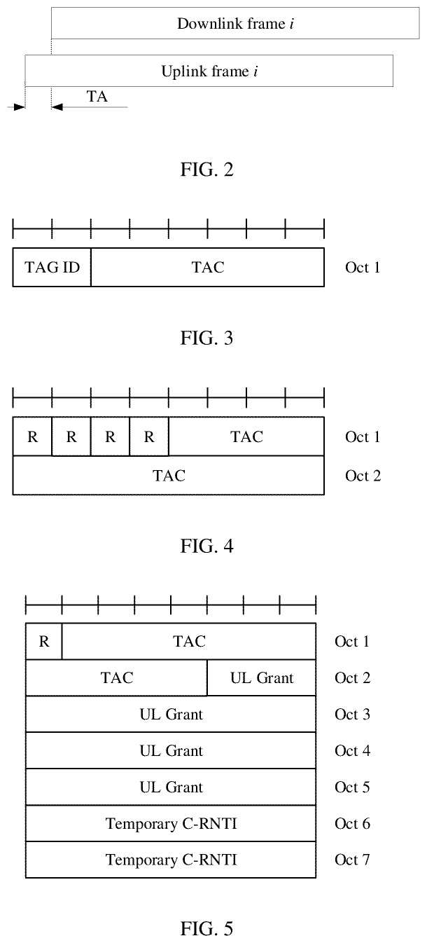

The TA is generally used for uplink transmission, and may mean that a system frame in which a terminal device transmits uplink data should be a specific time ahead of a corresponding downlink frame. For example, timing advance of a terminal device is performed in transmission on a basis of using the first path (that is, the first symbol of a slot in which a channel is located) of a downlink channel received by the terminal device as a downlink reference. FIG. 2 shows a relationship between an uplink frame and a downlink frame. Referring to FIG. 2, that a terminal device operates in a single TRP (sTRP) mode is used as an example. The terminal device transmits an uplink channel or a signal a specific time in advance (TA) with a downlink receive time point of the terminal device as a reference point.

A carrier aggregation scenario is used as an example. The terminal device may support different carriers (also referred to as “serving cells”). Different carriers may have different TA. Therefore, a concept of a TA group (TAG) is introduced. Generally, one TAG may include TA of one or more serving cells. A TAG including a special cell (Spcell) may be referred to as a primary timing advance group (PTAG), and correspondingly, another TAG other than the PTAG may be referred to as a secondary timing advance group (STAG). The Spcell may include a primary cell (PCell) or a primary secondary cell (PSCell).

In existing communications standards (including NR, 3GPP Rel.17, and the like), a maximum of four TAGs may be configured for a terminal device in a cell group (CG). RRC configuration used to configure a TAG may be represented as follows:

```
  -- ASN1START
  -- TAG-TAG-CONFIG-START
  TAG-Config ::= SEQUENCE {
  tag-ToReleaseList SEQUENCE (SIZE (1..maxNrofTAGs)) OF TAG-Id
OPTIONAL, -Need N
  tag-ToAddModList SEQUENCE (SIZE (1..maxNrofTAGs)) OF TAG
OPTIONAL-- Need N
  }
  TAG ::= SEQUENCE {
  tag-Id TAG-Id,
  timeAlignmentTimer TimeAlignmentTimer,
  ...
  }
  TAG-Id ::= INTEGER (0..maxNrofTAGs-1)
  TimeAlignmentTimer ::= ENUMERATED {ms500, ms750, ms1280,
ms1920, ms2560, ms5120, ms10240, infinity}
  -- TAG-TAG-CONFIG-STOP
  -- ASN1STOP
```

Generally, the RRC configuration may include TAG configuration (denoted by “TAG-Config”), TAG information (denoted by “TAG”), a TAG identifier (denoted by “TAG-Id”), and a TA timer (denoted by “TimeAlignmentTimer”). The TAG configuration may include a release list (denoted by “tag-ToReleaseList”) and a TAG add list (denoted by “tag-ToAddModList”). The TAG information may include an identifier of the TAG (denoted by “tag-Id”) and a TA timer (denoted by “timeAlignmentTimer”). Duration corresponding to the TA timer may be listed in an enumeration manner, including {500 ms, 750 ms, 1280 ms, 1920 ms, 2560 ms, 5120 ms, 10240 ms, and infinity}.

Generally, validity of TA may be maintained by using a TA timer. That is, when a terminal device receives information, transmitted by a network device, indicating the TA (or referred to as a TA command (TAC)), the terminal device may start or restart the TA timer. When the TA timer does not expire, the TA maintained by the TA timer is valid, and the terminal device may communicate with the network device based on the TA. On the contrary, when the TA timer expires, the TA maintained by the TA timer fails (or is invalid). In this case, the terminal device can no longer communicate with the network device based on the TA.

It should be noted that one CG may include a plurality of serving cells, and each serving cell is allocated a TAG identifier.

The following describes how to calculate TA.

In some implementations, TA may be calculated by using a formula (N_{TA}+N_{TA}, offset)×T_{c}, where N_{TA}, offset denotes a timing advance offset (TA offset), N_{TA} denotes a TA adjustment, T_{c} denotes a minimum time unit in a communications system (for example, an NR system), typically, T_{c}=1/(4096×480 kHz).

Generally, in one CG, each serving cell may be preconfigured with one N_{TA, offset}. In addition, N_{TA} may be performed based on a preconfigured offset.

In some implementations, for N_{TA}, differential adjustment may be provided by a MAC CE of the network device, that is, current TA adjustment (also referred to as “new TA”, denoted as N_{TA}_{_{new}}) is adjusted forward or backward in terms of time based on previous TA (also referred to as “old TA”, denoted by N_{TA}_{_{old}}). A calculation formula for the adjustment is as follows:

$${N}_{( {TA}_{new} )} = {N}_{( {TA}_{old} )} + ( {T}_{A} - 31 ) * 16 * 64 * / {2}^{μ}$$

In other words, N_{TA}_{_{old}} is a TA adjustment amount used before the TAC is received, and N_{TA}_{_{new}} is a TA adjustment amount updated after the TAC is received. T_{A} is determined based on the TAC. In addition, a granularity for the TA adjustment may be a TAG.

FIG. 3 shows a format of a MAC CE that carries a TAC. Referring to FIG. 3, the MAC CE may include a TAG identifier (TAG ID) field and a TAC field. Generally, a length of the TAG ID field may be 2 bits, and an identifier of the TAG that includes a SpCell is 0. The TAC field is used for indicating a TA index value TA (0, 1, 2 . . . 63), and controlling a timing adjustment that a MAC entity must apply (as specified in TS 38.213[6]). A length of the field may be 6 bits.

In other implementations, TA may be adjusted based on an absolute value of the TA (also referred to as “absolute TA”), that is, a previous TA adjustment value is not required to be considered. The network device may directly provide an absolute TA by using an absolute MAC CE or a payload of a MAC random access response (MAC RAR), and the absolute TA may be denoted by “N_{TA}” Generally, a value range of the absolute TA may range from 0 to 3846. Correspondingly, the TA may be calculated by using a formula N_{TA}=T_{A}×16×64×2^{μ}, where T_{A} is determined based on the TAC.

In some scenarios, the absolute TA and the acquiring manner of T_{A} described above occur in a random access procedure, and the acquired TA is applicable to a TAG corresponding to a target cell for random access. Therefore, signalling that carries the TAC may not include TAG-ID. For example, the absolute MAC CE may be used in a two-step random access procedure, and two-step random access may be initiated to the SpCell. Therefore, the absolute MAC CE is applicable to a PTAG corresponding to the MAC entity, that is, the PTAG includes the SpCell.

FIG. 4 shows a format of a MAC CE that carries a TAC. Referring to FIG. 4, a length of the MAC CE may be 2 bytes, namely, 16 bits. The MAC CE may include a TAC field, and the TAC field may occupy 12 bits. This field is used for indicating a TA index value of a time adjustment amount applied by a MAC entity. In addition, remaining 4 bits in the MAC CE may be used as reserved bits (denoted by “R”) and may be set to 0.

FIG. 5 shows a format of a MAC RAR that carries a TAC. Referring to FIG. 5, a length of the MAC RAR may be 7 bytes, namely, 56 bits. A first byte (denoted by “October 1”) may include a TAC field, and the TAC field may occupy 7 bits. This field is used for indicating a TA index value of a time adjustment amount applied by a MAC entity. The remaining 1 bit in the October 1 may be used as a reserved bit (denoted by “R”), and may be set to 0.

A second byte (denoted by “October 2”) may still include a TAC field, and the TAC field may occupy 5 bits. The remaining 3 bits in the October 2 may carry an uplink grant (UL Grant).

In a third byte to a fifth byte (denoted by “October 3 to October 5”), an uplink grant (UL Grant) may still be carried. In a sixth byte and a seventh byte (denoted by “October 6 and October 7”), a temporary cell radio network temporary identifier (C-RNTI) may be carried.

### Random Access Procedure

A terminal device may establish a connection to a cell by initiating a random access procedure, and obtain uplink synchronization information. Random access may include a four-step random access procedure and a two-step random access procedure. The following briefly describes a process of a random access procedure by using the four-step random access procedure as an example.

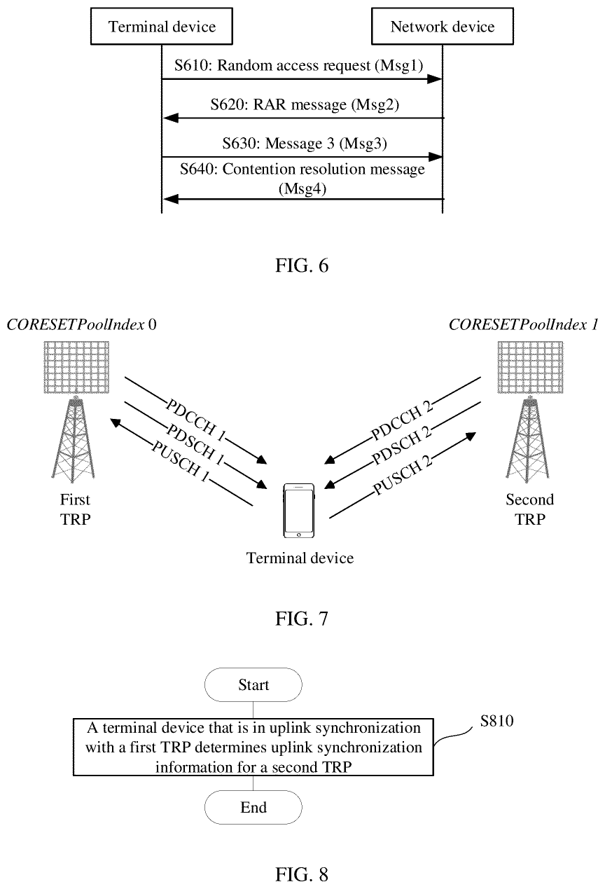

As shown in FIG. 6, the four-step random access procedure may include step S610 to step S640.

In step S610, a terminal device transmits a random access request to a network device, and the random access request may include a random access preamble. The random access request may also be referred to as a first message or a message 1 (Msg1) in the random access procedure.

In step S620, after the random access preamble transmitted by the terminal device is detected, the network device transits an RAR to the terminal device. An RAR message may also be referred to as a second message or a message 2 (Msg2) in the random access procedure.

In some embodiments, the RAR may include a TAC field for indicating uplink synchronization information used between the terminal device and the network device. In this way, in an initial access process, the terminal device may obtain an initial TA value by using the RAR message.

In step S630, the terminal device transmits a message 3 (Msg3) to the network device, where the message 3 may be used for instructing the network device to trigger an event of the random access procedure. For example, if the event is an initial access random procedure, a terminal device identity and an establishment cause are carried in the message 3; if the event is RRC reestablishment, an identity of a terminal device in a connected state and an establishment cause are carried in the message 3.

In step S640, the network device transmits a message 4 (Msg4) to the terminal device, where the message 4 may be used for conflict resolution. Therefore, the message 4 may also be referred to as a contention resolution message.

Scheduling in Multi-TRP (mTRP) Scenario

Referring to FIG. 7, in a scenario of multi-DCT-multi-TRP (mDCI-mTRP), TRPs may schedule transmission of their physical downlink shared channels (PDSCH) by using respective downlink control information (DCI). In other words, a TRP 1 may schedule transmission of a PDSCH 1 by using DCI carried in a physical downlink control channel (PDCCH) 1, and a TRP 2 may schedule transmission of a PDSCH 2 by using DCI carried in a PDCCH 2.

The applicant believes that in evolution of subsequent protocols, each TRP may schedule transmission of its PUSCH. Still referring to FIG. 7, that is, the TRP 1 may schedule transmission of a PUSCH 1 by using DCI carried in PDCCH 1, and the TRP 2 may schedule transmission of a PUSCH 2 by using DCI carried in the PDCCH 2.

It should be noted that in an mDCI-mTRP scenario, a demand for DCI is large, and each TRP performs scheduling independently, thus increasing a quantity of control resource sets (CORESET) associated with DCI. In some implementations, CORESETs may be grouped based on a corresponding RRC parameter “CORESETPoolIndex (CORESETPoolIndex)”, that is, control resource sets whose CORESETPoolIndex is “0” may be classified into one group corresponding to the TRP 1. Control resource sets whose CORESETPoolIndex is “1” may be classified into one group corresponding to the TRP 2. In addition, when a network device does not configure CORESETPoolIndex for a control resource set, CORESETPoolIndex may be “0” by default.

In addition, if a terminal device operates in an sTRP mode, a reference point of timing advance for the terminal device is a downlink receive time point. In an mTRP scenario, the terminal device may still use one of the two TRPs as a reference point for downlink reception to adjust TA. For example, a TRP whose CORESETPoolIndex is 0 is used as the reference point for downlink reception, or a specific TRP that may be configured by the network device is used as the reference point for downlink reception. In this case, a premise based on a single downlink reference point may be that the terminal device has only one set of downlink receive timelines, that is, depending on a capability of the terminal device.

Certainly, for a terminal device with a relatively strong capability, two different reference points for downlink reception may also be used. Still referring to FIG. 7, the two TRPs may correspond to different downlink reference points. In this case, two TA values indicated by the network device are adjusted according to respective reference points.

### Uplink Multi-TRP Operation

In an existing communication protocol (for example, 3GPP Rel.17), a repetition of a multi-TRP uplink PUCCH/PUSCH transmission is supported, with the aim of enhancing reliability of uplink coverage and transmission. A terminal device is required to transmit, to different TRPs, a physical uplink control channel (PUCCH)/a physical uplink shared channel (PUSCH) that carries same content. For a repetition of a PUSCH transmission, only a repetition of sDCI-based PUSCH transmission is supported in an existing standard, in which timing advance TA is used to sequentially transmit a PUSCH to different TRPs. For a repetition of mDCI-based PUSCH transmission, because there may not be enough ideal backhaul links between multiple TRPs as connections, independent scheduling of the multiple TRPs on the terminal device may cause overlapping of different PUSCHs/PUCCHs in terms of time.

In addition, 3GPP is currently working on a mechanism for a plurality of antenna panels of the terminal device to simultaneously transmit a PUCCH/PUSCH to multiple TRPs. However, in configuration of multiple uplink transmit antenna panels and multi-TRP reception, the terminal device can use only same uplink synchronization information (for example, using a same TA value) in one serving cell to perform advance transmission of a PUSCH/PUCCH (whether transmit to one TRP or two TRPs).

As described above, a serving cell is used as a granularity for uplink synchronization information between a conventional terminal device and a TRP. This manner of determining uplink synchronization information for a TRP by using the serving cell as a granularity may be too coarse, and thus interference may still occur when the terminal device communicates with a TRP based on uplink synchronization information corresponding to a serving cell to which the TRP belongs.

For example, if a serving cell includes multiple TRPs, there may be different distances between different TRPs and the terminal device. In this case, if the terminal device still transmits an uplink signal to the multiple TRPs in the serving cell based on uplink synchronization information corresponding to the serving cell, interference may still exist when the uplink signal arrives at the TRPs.

In addition, a synchronization error may exist between different TRPs. In this case, even if distances between the terminal device and different TRPs are the same, when the terminal device transmits an uplink signal to the different TRPs based on same uplink synchronization information, interference may still exist when the uplink signal arrives at the TRPs.

Based on this, in some communications systems, uplink synchronization information between a terminal device and a TRP may be determined by using a TRP as a granularity. In other words, for different TRPs, the terminal device may be required to separately determine uplink synchronization information of each TRP, for example, TA corresponding to respective TRPs (TRP-specific TA) is determined (for example, configured or adjusted) by using a TRP as a granularity. In this case, how to determine uplink synchronization information between a terminal device and a TRP is an urgent problem to be solved.

In a possible implementation, the terminal device may initiate a random access procedure to access a TRP to obtain uplink synchronization information for the TRP. However, a manner in which the terminal device obtains uplink synchronization information for a TRP by using the random access procedure is not flexible, which may cause high uplink resource overheads and a large transmission delay.

To solve the foregoing problem, this application provides two embodiments. In the two embodiments, the uplink synchronization information for a TRP may be obtained without initiating a random access procedure to the TRP, which helps reduce uplink resource overheads and a transmission delay. The following separately describes Embodiment 1 and Embodiment 2.

For ease of understanding, uplink synchronization information for the first TRP and the TRP is first described.

### First TRP

The first TRP refers to a TRP that keeps uplink synchronization with a terminal device, for example, the first TRP may be a TRP that is accessed when the terminal device initially accesses a serving cell.

In a multi-TRP scenario, the terminal device may keep uplink synchronization with one or more TRPs. In this case, the first TRP may be any one of the one or more TRPs that keeps uplink synchronization with the terminal device. This is not limited in embodiments of this application.

While the terminal device is in uplink synchronization with the first TRP, in some scenarios, a network side may add one or more other TRPs (for example, the second TRP described below) to provide a service for the terminal device according to a requirement of uplink/downlink transmission (for example, for improving transmission reliability or spectrum efficiency).

In some embodiments, a newly added TRP may be located in a same cell as the first TRP. In some embodiments, a newly added TRP may be located in a different cell from the first TRP.

In an example in which the first TRP is a TRP accessed when the terminal device initially accesses the serving cell, after initially accessing the serving cell, the terminal device enters a single TRP operation mode, and completes uplink synchronization with the first TRP. After the terminal device completes uplink synchronization with the first TRP, the first TRP may communicate with the terminal device as a serving TRP (corresponding to a base station) for transmitting a channel to the terminal device.

After the terminal device enters the single TRP operation mode, a network side may configure a multi-TRP operation mode for the terminal device as required, to add a new TRP to provide a service for the terminal device, for example, one or more TRPs in a same cell are added to provide a service for the terminal device.

When the multi-TRP operation mode is configured for the terminal device, multiple TRPs accessed by the terminal device may simultaneously provide a service for the terminal device. The multiple TRPs may communicate with each other, for example, may communicate in a wired connection or a wireless connection manner.

In some embodiments, the network side may configure the multi-TRP operation mode for the terminal device by using RRC signaling.

### Uplink Synchronization Information for TRP

Before a terminal device is required to perform uplink communication (transmitting uplink signalling or uplink data) with a TRP, the terminal device should perform uplink synchronization with the TRP, so as to avoid interference between uplink signals transmitted by different terminal devices to the TRP. Therefore, the terminal device is required to perform uplink synchronization with the TRP based on acquired uplink synchronization information for the TRP. The uplink synchronization information for the TRP may be understood as uplink synchronization information between the terminal device and the TRP, or may be understood as uplink synchronization information corresponding to the terminal device and the TRP.

That the terminal device performs uplink synchronization with the TRP based on the uplink synchronization information for the TRP may be understood as: A system frame in which the terminal device transmits uplink data should be a specific time ahead of a respective downlink frame. For example, uplink synchronization may be ensured by adjusting an uplink transmit time of the terminal device. It should be understood that adjustment of the uplink transmit time performed by the terminal device is targeted at alignment of reception time at a network side. The alignment herein includes that a plurality of terminal devices arrive at the network side at a same time as possible, and also includes alignment at the network side between boundaries of a downlink transmit slot and an uplink receive slot.

A type of uplink synchronization information for a TRP is not limited in embodiments of this application. For example, the uplink synchronization information for the TRP may refer to TA corresponding to the TRP (or referred to as TA between the TRP and the terminal device). For example, uplink synchronization information for a first TRP may refer to TA corresponding to the first TRP. Alternatively, the uplink synchronization information for the TRP may be a delay for unidirectional transmission from the TRP to the terminal device (or referred to as a unidirectional transmission delay between the terminal device and the TRP). For example, uplink synchronization information for a first TRP may be a delay for unidirectional transmission from the first TRP to the terminal device. In some embodiments, the delay for unidirectional transmission may also be referred to as a delay for unidirectional propagation. This is not limited in embodiments of this application.

In embodiments of this application, the TA corresponding to the TRP may be understood as twice as long as a delay for unidirectional transmission from the TRP to the terminal device.

Based on the foregoing related concepts, Embodiment 1 and Embodiment 2 are successively described below.

### Embodiment 1

In Embodiment 1, it is intended to determine uplink synchronization information of another TRP other than a first TRP by using the first TRP as a reference, so that there is no need to initiate a random access procedure to the another TRP to acquire the uplink synchronization information of the another TRP.

In some embodiments, a solution of acquiring uplink synchronization information without using a random access procedure may also be referred to as a RACH-less solution for acquiring uplink synchronization information.

With reference to FIG. 8, the following describes a process of determining uplink synchronization information of another TRP by using a first TRP as a reference in embodiments of this application.

FIG. 8 is a schematic flowchart of a wireless communication method according to an embodiment of this application. The method shown in FIG. 8 may be executed by a terminal device, or may be executed by a network device. This is not limited in embodiments of this application. The terminal device and the network device may be, for example, the terminal device 120 and the network device 110 shown in FIG. 1 (for example, the network device 110 in FIG. 1A, the satellite 110a in FIG. 1B, and the base station 110b in FIG. 1C). The method shown in FIG. 8 includes step S810. The following describes this step in detail.

In step S810, the terminal device, when being in uplink synchronization with a first TRP, determines uplink synchronization information for a second TRP.

The second TRP may be understood as a TRP newlyconfigured by a network side for the terminal device, so that the second TRP may provide a service for the terminal device together with the first TRP. The second TRP and the first TRP may be located in a same cell, or may be located in different cells. This is not limited in embodiments of this application.

In some embodiments, the terminal device has not connected to the second TRP, or the terminal device has not performed uplink synchronization with the second TRP. However, embodiments of this application are not limited thereto. In a case that the terminal device has connected to the second TRP (or the terminal device is required to update the uplink synchronization information for the second TRP after accessing the second TRP), the terminal device may also determine the uplink synchronization information for the second TRP by using the first TRP as a reference.

In some embodiments, downlink transmissions from the first TRP and the second TRP to the terminal device are synchronous. In other words, a transmission timing difference between the first TRP and the second TRP is 0 (or no transmission timing difference exists between the first TRP and the second TRP).

In some embodiments, downlink transmissions from the first TRP and the second TRP to the terminal device are not synchronous. In other words, the transmission timing difference between the first TRP and the second TRP is a non-zero value. This is because a clock deviation may exist between the first TRP and the second TRP (for example, a clock deviation caused by an undesired backhaul link between the first TRP and the second TRP or hardware limitation of the network device), and thus there is an unpredictable error in downlink time synchronization between the first TRP and the second TRP. In embodiments of this application, the clock deviation between the first TRP and the second TRP is referred to as a transmission timing difference between the first TRP and the second TRP. In some embodiments, the transmission timing difference may also be replaced with another name, for example, a synchronization time difference, a downlink transmission time gap (DL Tx time gap), or a downlink transmit timing difference. This is not limited in this application, provided that the name indicates a clock deviation between different TRPs.

In some embodiments, determining the uplink synchronization information for the second TRP by using the first TRP as a reference may refer to that information related to the first TRP may be considered during determining of the uplink synchronization information for the second TRP. Specifically, the uplink synchronization information for the second TRP may be determined according to one or more of the following information.

### Information 1: Uplink Synchronization Information for the First TRP.

The uplink synchronization information for the first TRP may refer to TA corresponding to the first TRP, or may refer to a delay for unidirectional transmission from the first TRP to the terminal device.

In some embodiments, a type of the uplink synchronization information for the first TRP may be the same as a type of the uplink synchronization information for the second TRP. For example, the uplink synchronization information for the first TRP refers to TA corresponding to the first TRP, and the uplink synchronization information for the second TRP refers to TA corresponding to the second TRP. In some embodiments, the type of the uplink synchronization information for the first TRP may be different from the type of the uplink synchronization information for the second TRP. For example, the uplink synchronization information for the first TRP refers to TA corresponding to the first TRP, and the uplink synchronization information for the second TRP refers to a delay for unidirectional transmission from the second TRP to the terminal device.

### Information 2: Downlink Time Difference of Arrival

The downlink time difference of arrival is used for indicating a difference between a time at which a signal of the first TRP arrives at the terminal device and a time at which a signal of the second TRP arrives at the terminal device. Alternatively, the downlink time difference of arrival indicates a difference between a downlink arrival time for transmission from the first TRP to the terminal device (a time at which a signal transmitted by the first TRP arrives at the terminal device) and a downlink arrival time for transmission from the second TRP to the terminal device.

In some embodiments, the downlink time difference of arrival may also be indicated by using a downlink reception time of the terminal device, namely, a difference between a time at which the terminal device receives a signal transmitted by the first TRP and a time at which the terminal device receives a signal transmitted by the second TRP.

In some embodiments, the downlink time difference of arrival may be determined based on measurement performed by the terminal device on a reference signal. For details, refer to the following description, and details are not described herein again.

In some embodiments, a downlink arrival time for transmission from a TRP to the terminal device is associated with a distance from the TRP to the terminal device. For example, when a distance from the first TRP to the terminal device is the same as a distance from the second TRP to the terminal device, it may be considered that a downlink time difference of arrival is 0. Alternatively, when the distance from the first TRP to the terminal device is different from the distance from the second TRP to the terminal device, it may be considered that the downlink time difference of arrival is a non-zero value.

### Information 3: A Transmission Timing Difference Between the First TRP and the Second TRP

The transmission timing difference between the first TRP and the second TRP is used for indicating synchronization information of downlink transmission from the first TRP and the second TRP to the terminal device (or information of a clock deviation between the first TRP and the second TRP). For example, when the transmission timing difference between the first TRP and the second TRP is 0, it may be understood that downlink transmissions from the first TRP and the second TRP to the terminal device are synchronous, or clock information of the first TRP and clock information of the second TRP are the same. For another example, when the transmission timing difference between the first TRP and the second TRP is a non-zero value, it may be understood that downlink transmissions from the first TRP and the second TRP to the terminal device are not synchronous, or clock information of the first TRP and clock information of the second TRP are not the same.

In some embodiments, the transmission timing difference between the first TRP and the second TRP may refer to a difference between time reference information of the first TRP and time reference information of the second TRP. Optionally, the time reference information of the first TRP may be indicated by a downlink transmit time of the first TRP, and the time reference information of the second TRP may be indicated by a downlink transmit time of the second TRP.

In some embodiments, the transmission timing difference between the first TRP and the second TRP may be determined based on system information of the first TRP and the second TRP or time reference information included in dedicated signalling of the first TRP and the second TRP. System information of a TRP is not limited in this application. For example, the system information may refer to a system information block (SIB).

In embodiments of this application, when the terminal device keeps uplink synchronization with the first TRP, the terminal device may determine the uplink synchronization information for the second TRP by using the first TRP as a reference. Specifically, one or more of the information 1 to the information 3 described above may be considered for determining the uplink synchronization information for the second TRP. Based on this, the terminal device may obtain the uplink synchronization information for the second TRP without initiating a random access procedure to the second TRP, thereby helping to reduce uplink resource overheads and a transmission delay.

In some embodiments, the uplink synchronization information for the second TRP may be determined based on the information 1 and the information 2 described above. For example, in a case that downlink transmissions from the first TRP and the second TRP to the terminal device are synchronous, the uplink synchronization information for the second TRP may be directly determined based on the information 1 and the information 2.

In some embodiments, the uplink synchronization information for the second TRP may be jointly determined based on the information 1, the information 2, and the information 3 described above, that is, the uplink synchronization information for the second TRP is determined based on the uplink synchronization information for the first TRP, the downlink time difference of arrival, and the transmission timing difference between the first TRP and the second TRP. For example, in a case that downlink transmissions from the first TRP and the second TRP to the terminal device are synchronous, it may be considered that a transmission timing difference between the first TRP and the second TRP is 0, and the uplink synchronization information for the second TRP is jointly determined based on the information 1, the information 2, and the information 3. Alternatively, in a case that downlink transmissions from the first TRP and the second TRP to the terminal device are not synchronous, it may be considered that a transmission timing difference between the first TRP and the second TRP is a non-zero value, and the uplink synchronization information for the second TRP is jointly determined based on the information 1, the information 2, and the information 3.

In an implementation, if the uplink synchronization information for the second TRP is determined based on the information 1, the information 2, and the information 3 described above, and when the uplink synchronization information for the second TRP is TA corresponding to the second TRP, the uplink synchronization information for the second TRP may be represented as twice a target value. The target value is equal to a sum of the downlink time difference of arrival and a difference between a delay for unidirectional transmission (the delay for unidirectional transmission from the first TRP to the terminal device) and the transmission timing difference (the transmission timing difference between the first TRP and the second TRP).

It should be understood that the transmission timing difference between the first TRP and the second TRP and the downlink time difference of arrival are all relative concepts. Therefore, the subtraction operation or addition operation described above is not absolute. For example, the subtraction operation may be understood as a sum with a negative value.

The transmission timing difference between the first TRP and the second TRP is used as an example. The transmission timing difference may be obtained by subtracting a reference time of the first TRP from a reference time of the second TRP. If the reference time of the second TRP is later than the reference time of the first TRP, the transmission timing difference between the first TRP and the second TRP may be represented as a positive value, and the difference between a delay for unidirectional transmission and the transmission timing difference described above may be a value obtained by subtracting the transmission timing difference from the delay for unidirectional transmission. If the reference time of the second TRP is earlier than the reference time of the first TRP, the transmission timing difference between the first TRP and the second TRP may be represented as a negative value, and the difference between the delay for unidirectional transmission and the transmission timing difference described above may refer to a value obtained by subtracting the transmission timing difference from the delay for unidirectional transmission (in this case, minus a negative value may be understood as a sum with a positive value). Certainly, a related calculation process of the transmission timing difference between the first TRP and the second TRP is similar, and details are not described herein again.

As described above, downlink transmissions from the first TRP and the second TRP to the terminal device may be synchronous, or may be not synchronous. The following exemplarily describes how to determine the uplink synchronization information for the second TRP for each of the two cases.

Case 1: Downlink Transmissions from the First TRP and the Second TRP to the Terminal Device are Synchronous.

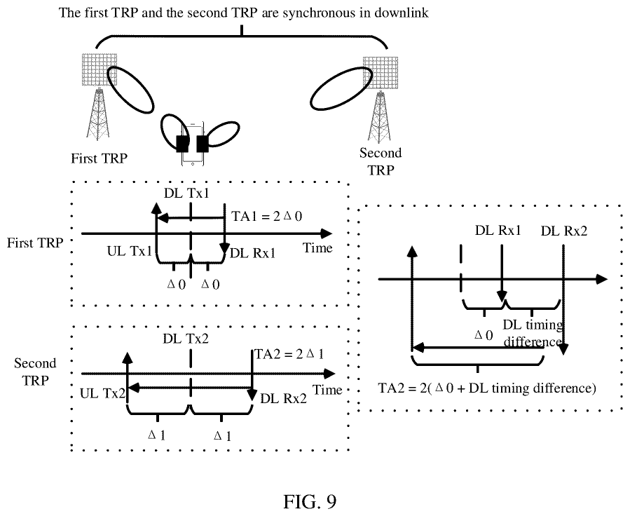

FIG. 9 shows an example of determining uplink synchronization information for a second TRP. In the example of FIG. 9, downlink transmissions from the first TRP and the second TRP to the terminal device are synchronous (that is, DL Tx1 and DL Tx2 in FIG. 9 are aligned, where DL Tx denotes downlink transmission, and DL RX denotes downlink reception). In this case, if the uplink synchronization information for the first TRP is different from the uplink synchronization information for the second TRP, the cause may be that a delay for propagation from the terminal device to the first TRP is different from a delay for propagation from the terminal device to the second TRP. Specifically, assuming that delays for unidirectional transmission from the first TRP and the second TRP to the terminal device are respectively Δ₀ and Δ₁, for the terminal device, a value of TA corresponding to the first TRP and a value of TA corresponding to the second TRP should be respectively 2Δ₀ and 2Δ₁ to compensate for a round-trip time.

It is assumed that the terminal device has performed uplink synchronization with the first TRP (for example, the uplink synchronization information for the first TRP is configured or updated by using an initially accessed MAC RAR and a subsequent MAC CE). In this case, the terminal device may determine the uplink synchronization information (for example, a delay Δ₀ for unidirectional propagation from the first TRP to the terminal device) for the first TRP (for example, through calculation or indication by a network device). In this way, as long as the terminal device can determine the downlink time difference of arrival, the terminal device may determine the uplink synchronization information for the second TRP according to the formulas below.

When the uplink synchronization information for the second TRP is TA corresponding to the second TRP, TA1=2(Δ₀+DL timing difference). When the uplink synchronization information for the second TRP is a delay for unidirectional transmission from the second TRP to the terminal device, TA2=Δ₀+DL timing difference.

Δ₀ denotes the delay for unidirectional transmission from the first TRP to the terminal device, and DL timing difference denotes a downlink time difference of arrival.

Case 2: Downlink Transmissions from the First TRP and the Second TRP to the Terminal Device are not Synchronous.

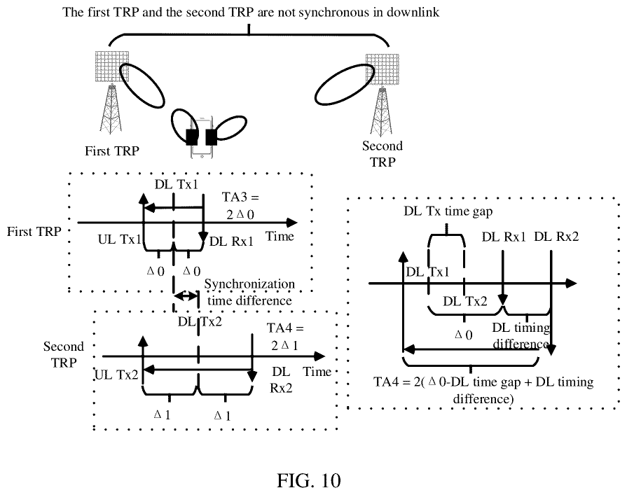

FIG. 10 shows an example of determining uplink synchronization information for a second TRP. In the example of FIG. 10, downlink transmissions from the first TRP and the second TRP to the terminal device are not synchronous, that is, there is a transmission timing difference between the first TRP and the second TRP, and the transmission timing difference is a non-zero value. In this case, if the uplink synchronization information for the first TRP is different from the uplink synchronization information for the second TRP, it may be caused by one or more of the following causes: a delay for propagation from the terminal device to the first TRP is different from that from the terminal device to the second TRP; or downlink transmissions from the first TRP and the second TRP to the terminal device are not synchronous.

It is assumed that the terminal device has performed uplink synchronization with the first TRP, that is, the terminal device may determine the uplink synchronization information for the first TRP. In this case, the terminal device further needs to determine a downlink time difference of arrival and a transmission timing difference between the first TRP and the second TRP. Thus, the terminal device may determine the uplink synchronization information for the second TRP according to the formulas below.

When the uplink synchronization information for the second TRP is TA corresponding to the second TRP, TA3=2(Δ₀−DL time gap+DL timing difference). When the uplink synchronization information for the second TRP is a delay for unidirectional transmission from the second TRP to the terminal device, TA4=Δ₀−DL time gap+DL timing difference.

Δ₀ denotes a delay for unidirectional transmission from the first TRP to the terminal device, DL time gap denotes a transmission timing difference between the first TRP and the second TRP, and DL timing difference denotes a downlink time difference of arrival.

As described above, both the terminal device and the network device may determine the uplink synchronization information for the second TRP based on the information 1 to information 3 described above. The following separately describes the processes of how the terminal device and the network device determine the uplink synchronization information for the second TRP based on the information described above.

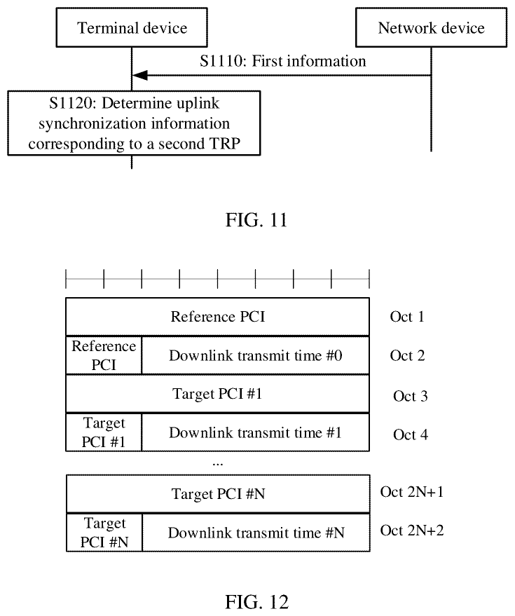

FIG. 11 is a schematic flowchart of a wireless communication method according to another embodiment of this application. The flowchart is used to describe how the terminal device determines the uplink synchronization information for the second TRP based on the information described above. The method illustrated in FIG. 11 is described from a perspective of interaction between a terminal device and a network device.

When the terminal device determines the uplink synchronization information for the second TRP based on the information described above, the terminal device may determine the uplink synchronization information for the first TRP and the downlink time difference of arrival, and the transmission timing difference between the first TRP and the second TRP may be indicated by the network device.

In step S1110, the network device transmits first information to the terminal device, where the first information is used for indicating a transmission timing difference between the first TRP and the second TRP.

In some embodiments, the first information may be carried in higher layer signalling, such as RRC signalling. In some embodiments, the first information may be carried in lower layer signalling, such as a MAC CE.

In some embodiments, considering that a transmission timing difference between TRPs may not be frequently changed, an indication manner for the first information may be configured as a semi-static configuration manner, for example, semi-static configuration may be performed by using higher layer signalling.

In some embodiments, to more dynamically adjust a transmission timing difference between TRPs, the indication manner for the first information may be configured as a dynamic configuration manner, for example, dynamic configuration may be performed by using lower layer signalling.

A manner in which the first information indicates the transmission timing difference between the first TRP and the second TRP is not limited in embodiments of this application. In some embodiments, the first information may be indicated in a manner of an absolute time. That time reference information of a TRP is indicated by using a downlink transmit time of the TRP is used as an example. The first information may include a downlink transmit time of the first TRP and a downlink transmit time of the second TRP. After receiving the first information, the terminal device may obtain a transmission timing difference between the first TRP and the second TRP through calculation based on the downlink transmit time of the first TRP and the downlink transmit time of the second TRP, where the transmission timing difference is equal to a difference between the downlink transmit time of the first TRP and the downlink transmit time of the second TRP. In some embodiments, the first information may be indicated in a manner of a relative timing difference. That time reference information of a TRP is indicated by using a downlink transmit time of the TRP is still used as an example. The first information may directly include a difference between a downlink transmit time of the first TRP and a downlink transmit time of the second TRP, that is, the transmission timing difference between the first TRP and the second TRP may be directly included in the first information.

In some embodiments, the first information may be used for indicating a transmission timing difference between the first TRP (reference TRP) and a plurality of target TRPs (the second TRP is one of the plurality of target TRPs). In this case, to distinguish between different target TRPs, an identifier of a TRP may be used to distinguish between different TRPs.

In some embodiments, the identifier of a TRP may be a physical cell identifier (PCI) of the TRP. For TRPs, each TRP has a corresponding PCI, and for an intra-cell multi-TRP scenario, PCIs corresponding to the multiple TRPs are the same; for an inter-cell multi-TRP scenario, PCIs corresponding to the multiple TRP s are different. Based on this, in the inter-cell multi-TRP scenario, a PCI may be used to distinguish between different TRPs.

FIG. 12 shows a format of a MAC CE indicating a transmission timing difference. The example in FIG. 12 may be applied to the inter-cell multi-TRP scenario. As shown in FIG. 12, a transmission timing difference between a reference TRP and a target TRP is indicated in a manner of an absolute time. Each TRP (including a reference TRP and a target TRP) has a corresponding PCI, and different TRPs may be distinguished from each other by using respective PCIs of TRPs.

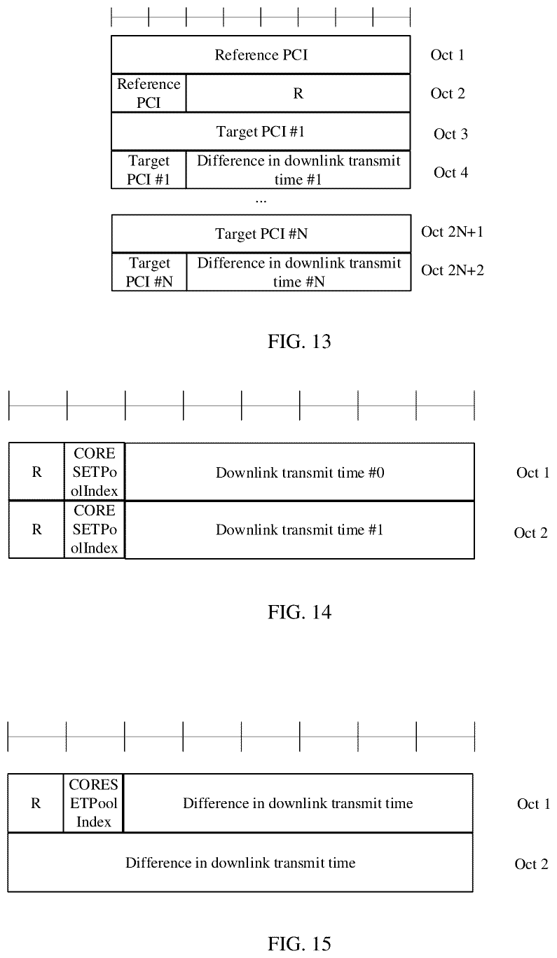

FIG. 13 shows another format of a MAC CE indicating a transmission timing difference. The example in FIG. 13 may be applied to the inter-cell multi-TRP scenario. As shown in FIG. 13, a transmission timing difference between a reference TRP and a target TRP is indicated in a manner of a relative timing difference. Each TRP (including a reference TRP and a target TRP) has a corresponding PCI, and different TRPs may be distinguished from each other by using respective PCIs of TRPs.

In some embodiments, an identifier of a TRP may refer to an identifier of a CORESET associated with the TRP. For TRPs, each TRP is associated with a group of CORESETs, so that an identifier of a CORESET may be used to indirectly distinguish between different TRPs. Based on this, in the intra-cell multi-TRP scenario, identifiers of the CORESETs may be used to distinguish between different TRPs.

In some embodiments, an identifier of a CORESET refers to an RRC parameter “CORESETPoolIndex” corresponding to the CORESET, that is, the parameter “CORESETPoolIndex” may be used to distinguish between different TRPs. Considering that CORESETPoolIndex can only be 0 or 1, and the two values correspond to two different TRPs respectively. Therefore, CORESETPoolIndex may be used to distinguish between two different TRPs.

FIG. 14 shows a still another format of a MAC CE indicating a transmission timing difference. The example in FIG. 14 may be applied to the intra-cell multi-TRP scenario. As shown in FIG. 14, a transmission timing difference between a reference TRP and a target TRP is indicated in a manner of an absolute time. The reference TRP and the target TRP may be distinguished from each other by CORESETPoolIndex respectively associated with them.

FIG. 15 shows a still another format of a MAC CE indicating a transmission timing difference. The example in FIG. 15 may be applied to the intra-cell multi-TRP scenario. As shown in FIG. 15, a transmission timing difference between a reference TRP and a target TRP is indicated in a manner of a relative timing difference. The reference TRP and the target TRP may be distinguished from each other by using CORESETPoolIndex associated with respective TRPs.

Still referring to FIG. 11, in step S1120, the terminal device determines the uplink synchronization information for the second TRP.

For a description of step S1120, reference may be made to the related description of step S810 described above. Details are not described herein again.

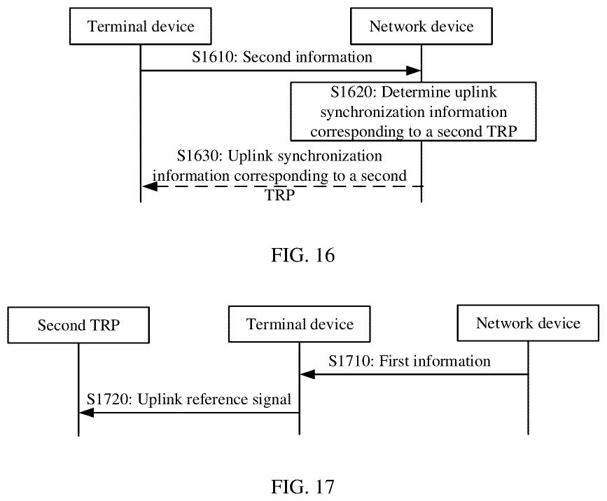

FIG. 16 is a schematic flowchart of a wireless communication method according to still another embodiment of this application. The flowchart is used to describe how the network device determines the uplink synchronization information for the second TRP based on the information described above. The method illustrated in FIG. 16 is described from a perspective of interaction between a network device and a terminal device.

When the network device determines the uplink synchronization information for the second TRP based on the information described above, the network device may determine the uplink synchronization information for the first TRP and a transmission timing difference between the first TRP and the second TRP, and the downlink time difference of arrival may be indicated by the terminal device.

In step S1610, the terminal device transmits second information to the network device, where the second information is used for indicating the downlink time difference of arrival.

In some embodiments, if the first TRP and the second TRP are located in different cells, the second information is further used for indicating a cell corresponding to the second TRP. For example, the second information may include a PCI of the second TRP, which is used for indicating a cell corresponding to the second TRP.

In some embodiments, the second information may be carried in lower layer signalling, such as a MAC CE.

In some embodiments, the terminal device may independently transmit (or report) the second information to the network device. For example, the second information is independently carried in the MAC CE for transmission.

In some embodiments, the terminal device may merge the second information and other information into same signalling and transmit the signalling to the network device. For example, the terminal device may merge the second information into channel state information (CSI) reporting content (such as a channel quality indication (CQI), a rank indication (RI), and a precoding matrix indicator (PMI)) and transmit them together to the network device.

In step S1620, the network device determines the uplink synchronization information for the second TRP.

For a description of step S1620, reference may be made to the related description of step S810 described above. Details are not described herein again.

In some embodiments, the method may further include step S1630. In step S1630, the network device transmits third information to the terminal device, where the third information is used for indicating the uplink synchronization information for the second TRP.

After determining the uplink synchronization information for the second TRP, the network device may notify the terminal device of the uplink synchronization information for the second TRP.

In some embodiments, the third information may be carried in lower layer signalling, such as MAC CE.

In embodiments of this application, both the terminal device and the network device may determine uplink synchronization information for the second TRP, thereby increasing a possibility that the terminal device independently corrects the uplink synchronization information for the TRP.

As mentioned above, the terminal device may determine a downlink time difference of arrival based on measurement on a reference signal, which is described below.

In an implementation, each of the first TRP and the second TRP may transmit a downlink reference signal to the terminal device, the terminal device measures the downlink reference signal from the first TRP and the downlink reference signal from the second TRP, and determines a downlink time difference of arrival based on a measurement result.

A type of a downlink reference signal (for example, the first downlink reference signal and/or the second downlink reference signal described below) is not limited in embodiments of this application. For example, the downlink reference signal may be a synchronization signal block (SS/PBCH block, SSB), or may be a channel state information reference signal (CSI-RS).

It is assumed that the downlink time difference of arrival is determined based on measurement on the first downlink reference signal and the second downlink reference signal, the first downlink reference signal corresponds to the first TRP, and the second downlink reference signal corresponds to the second TRP. It should be understood that the first downlink reference signal being corresponding to the first TRP may mean that the first downlink reference signal is transmitted by the first TRP, and the second downlink reference signal being corresponding to the second TRP may mean that the second downlink reference signal is transmitted by the second TRP.

When the terminal device determines the downlink time difference of arrival based on measurement on a downlink reference signal, the terminal device needs to know a correspondence between the downlink reference signal and a TRP, that is, the terminal device needs to know that the first downlink reference signal is transmitted by the first TRP, and the second downlink reference signal is transmitted by the second TRP.

In some embodiments, the terminal device may determine a correspondence between a downlink reference signal and a TRP by using identifier information of the TRP.

For example, in an inter-cell multi-TRP scenario, PCIs corresponding to different TRPs may be different. A PCI of a TRP may be used as an identifier of the TRP to determine a correspondence between a downlink reference signal and the TRP.

For example, in an intra-cell multi-TRP scenario, each TRP is associated with a group of CORESETs. CORESET groups associated with different TRPs may be different. Therefore, a downlink reference signal may be associated with a CORESET group, and a correspondence between a downlink reference signal and a TRP is indirectly determined by using an association relationship between the downlink reference signal and the CORESET group. In other words, both a TRP and a downlink reference signal may be associated with a CORESET group, so that a correspondence between the downlink reference signal and the TRP may be indirectly determined by using an association relationship between the CORESET group and a downlink reference signal. For example, both a first TRP and a first downlink reference signal may be associated with a first group of CORESETs, and both a second TRP and a second downlink reference signal may be associated with a second group of CORESETs. In this case, the terminal device may identify, by determining a CORESET group, a TRP to which a downlink reference signal is transmitted. In this implementation, the identifier information of the TRP may refer to identifier information of a CORESET associated with the TRP, for example, an RRC parameter “CORESETPoolIndex” of the CORESET.

In some embodiments, the network device may directly indicate a correspondence between a downlink reference signal and a TRP to the terminal device.

That a downlink reference signal is an SSB is used as example. For two TRPs, the network device configures a specific quantity of SSBs for each TRP as a downlink reference signal. For example, SSBs whose SSB identifiers ranging from 0 to 31 (32 in total) may be transmitted from a first TRP, and SSBs whose SSB identifiers ranging from 32 to 63 (32 in total) may be transmitted from a second TRP. The network device may directly indicate a correspondence between an SSB and a TRP to the terminal device, for example, indicate the correspondence between an SSB identifier and a TRP to the terminal device, so that the terminal device identifies a TRP from which a downlink reference signal is transmitted.

A case in which the downlink reference signal is a CSI-RS is similar to a case in which the downlink reference signal is an SSB, and details are not described herein again.

In some embodiments, after the terminal device determines the uplink synchronization information for the second TRP (including determining by the terminal device itself by means of calculation or indicating to the terminal device by the network device after determination), the terminal device may reset a first timer, where the first timer is used to maintain validity of the uplink synchronization information for the second TRP. The first timer may be a TA timer (denoted by TimeAlignmentTimer) of the terminal device. The terminal device may reset the first timer to avoid unnecessary uplink out-of-synchronization.

### Embodiment 2

In Embodiment 2, it is intended to determine uplink synchronization information of an activated TRP by using a process of activating a TRP to provide a service for a terminal device, and a random access procedure is not required to be initiated to the TRP to acquire the uplink synchronization information for the TRP.

In an inter-cell multi-TRP scenario, the terminal device first establishes uplink synchronization with a TRP in a serving cell. For a TRP in a non-serving cell, no uplink synchronization is established. With reference to FIG. 17, Embodiment 2 is described by using an example in which the terminal device establishes uplink synchronization with a first TRP (that is, the terminal device and the first TRP maintain uplink synchronization), and does not establish uplink synchronization with a second TRP, where the first TRP and the second TRP are located in different cells.

FIG. 17 is a schematic flowchart of a wireless communication method according to still another embodiment of this application. The method shown in FIG. 17 includes step S1710 and step S1720. The following describes these steps in detail.

In step S1710, a network device transmits first information to a terminal device, where the first information is used for activating a second TRP.

In some embodiments, the first information is determined based on measurement performed by the terminal device on a downlink reference signal of the second TRP.

The downlink reference signal of the second TRP may include a plurality of types, for example, an SSB or a CSI-RS. The downlink reference signal of the second TRP being a CSI-RS is used as an example. The CSI-RS may be a CSI-RS used for beam management, or may be a CSI-RS used for mobility management. This is not limited in embodiments of this application.

In some embodiments, the downlink reference signal may be preconfigured by the network device, for example, preconfigured by the network device through RRC signalling.

In some embodiments, the first information may be a unified transmission configuration indicator (TCI) state.

In some embodiments, the first information may be carried in a MAC CE, for example, the network device activates the unified TCI state through MAC CE signalling. In some embodiments, the first information may be carried in DCI, for example, the network device configures a unified TCI state through MAC CE signalling, and activates the unified TCI state through DCI signalling.

In some embodiments, the first information may include a resource for transmitting a downlink reference signal, and the resource corresponds to the second TRP. In other words, the resource for the downlink reference signal included in the first information may be from a TRP that has a different PCI from a TRP (for example, the first TRP) in a serving cell.

In step S1720, in response to the first information, the terminal device transmits an uplink reference signal to the second TRP, where the uplink reference signal is used by the network device to determine uplink synchronization information for the second TRP.

In some embodiments, in addition to being used by the network device to determine the uplink synchronization information for the second TRP, the uplink reference signal may be further used by the network device to measure a channel of the terminal device relative to the second TRP, so as to estimate uplink/downlink CSI between the terminal device and the second TRP.

A type of the uplink reference signal is not limited in embodiments of this application. For example, the uplink reference signal may be an SRS, for example, an aperiodic SRS.

In some embodiments, a transmit beam of the uplink reference signal corresponds to a receive beam of the downlink reference signal, so as to ensure beam symmetry of uplink and downlink transmission. In other words, the transmit beam of the uplink reference signal may correspond to a beam that the terminal device receives the downlink reference signal. The uplink reference signal being an SRS, and the downlink reference signal being an SSB/CSI-RS are used as an example. A transmit beam of the SRS is correspondingly a beam that the terminal device receives the downlink reference signal SSB/CSI-RS.

In some embodiments, a transmit time of the uplink reference signal is determined based on a receive time of the downlink reference signal. In an implementation, the uplink reference signal is transmitted in a receive time of the downlink reference signal, for example, is transmitted in the first multipath receive time of the downlink reference signal. In other words, TA may be not performed on the transmit time of the uplink reference signal, so that the network device determines the uplink synchronization information for the second TRP based on an arrival time of the uplink reference signal. In another implementation, a receive time of the downlink reference signal may be used as a reference time, and the transmit time of the uplink reference signal is determined based on the reference time. For example, the uplink reference signal is transmitted a specific time ahead of the receive time of the downlink reference signal. In other words, corresponding TA may be configured for the transmit time of the uplink reference signal, and the terminal device uses the receive time of the downlink reference signal as a reference point, and transmits the uplink reference signal ahead of a corresponding TA value.

A TA acquiring manner corresponding to the transmit time of the uplink reference signal is not limited in embodiments of this application. For example, the TA may use a value of TA corresponding to the first TRP. Alternatively, the network device may configure, in advance, the TA corresponding to the transmit time of the uplink reference signal for the terminal device, for example, through RRC signalling.

In embodiments of this application, in a process of activating the second TRP to provide a service for the terminal device, the terminal device may transmit an uplink reference signal to the second TRP, so that the network device determines uplink synchronization information for the second TRP based on the uplink reference signal. In this way, the uplink synchronization information for the second TRP may be determined by using an existing inter-cell multi-TRP operation, to reduce an unnecessary random access procedure for the terminal device, and thus signalling overheads of a system and a delay for a random access procedure may be reduced.

In some embodiments, a process of activating the second TRP to provide a service for the terminal device may refer to a process of beam management between the terminal device and the second TRP. The following exemplarily describes implementation steps of Embodiment 2 by using the process of beam management between the terminal device and the second TRP as an example.

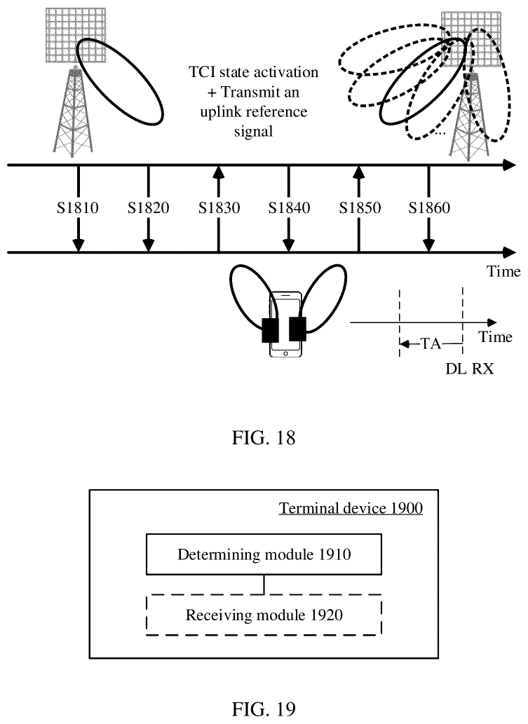

Referring to FIG. 18, in step S1810, a network device configures, for a terminal device, a downlink reference signal, such as an SSB or a CSI-RS, used for an inter-cell multi-TRP transmission.

In some embodiments, the network device may configure the downlink reference signal for the terminal device through RRC signalling.

In step S1820, the terminal device measures a downlink reference signal of a second TRP (different from a PCI of a first TRP).

In step S1830, the terminal device performs beam reporting. Content of beam reporting of the terminal device may include identifier information of the downlink reference signal and/or L1 reference signal received power (L1 reference signal receiving power, L1-RSRP) corresponding to the downlink reference signal.

In step S1840, the network device indicates a unified TCI state to the terminal device. A downlink reference signal resource included in the unified TCI state is from the second TRP.

In some embodiments, the network device may activate the unified TCI state through MAC CE signalling, or may indicate the unified TCI state through MAC CE+DCI signalling.

In step S1850, the terminal device transmits an uplink reference signal to the second TRP, for example, transmits an aperiodic SRS.

In some embodiments, a transmit beam of the uplink reference signal is correspondingly a beam that the terminal device receives a downlink reference signal.

In some embodiments, the transmit time of the uplink reference signal may not be advanced at all, that is, the terminal device transmits the uplink reference signal in a receive time for reporting the downlink reference signal. In some embodiments, a TA value corresponding to the first TRP or a TA value configured by the network device for the terminal device in advance may be used for the transmit time of the uplink reference signal.

In step S1860, the network device determines the uplink synchronization information for the second TRP, that is, the network device determines uplink synchronization information corresponding to the terminal device for the second TRP, for example, TA corresponding to the terminal device for the second TRP.

In some embodiments, after determining the uplink synchronization information for the second TRP, the network device may update the uplink synchronization information for the terminal device and the second TRP through a MAC CE.

Method embodiments of this application are described above in detail with reference to FIG. 1 to FIG. 18, and apparatus embodiments of this application will be described below in detail with reference to FIG. 19 to FIG. 23. It should be understood that the description of the method embodiments corresponds to the description of the apparatus embodiments, and therefore, for parts that are not described in detail, reference may be made to the foregoing method embodiments.

FIG. 19 is a schematic structural diagram of a terminal device according to an embodiment of this application. The terminal device 1900 shown in FIG. 19 may include a determining module 1910.

The determining module 1910 may determine, when the terminal device is being in uplink synchronization with a first transmission-reception point TRP, uplink synchronization information for a second TRP. The uplink synchronization information for the second TRP is determined based on one or more of the following information: uplink synchronization information for the first TRP; a downlink time difference of arrival, where the downlink time difference of arrival is used for indicating a difference between a time at which a signal of the first TRP arrives at the terminal device and a time at which a signal of the second TRP arrives at the terminal device; or a transmission timing difference between the first TRP and the second TRP.

Optionally, the uplink synchronization information for the second TRP is determined based on the uplink synchronization information for the first TRP, the downlink time difference of arrival, and the transmission timing difference.

Optionally, the uplink synchronization information for the first TRP is a delay for unidirectional transmission from the first TRP to the terminal device, the uplink synchronization information for the second TRP is timing advance TA corresponding to the second TRP, and the TA corresponding to the second TRP is twice a target value. The target value is equal to a sum of the downlink time difference of arrival and a difference between the delay for unidirectional transmission and the transmission timing difference.

Optionally, the terminal device 1900 further includes a receiving module 1920. The receiving module 1920 may be configured to receive first information from a network device, where the first information is used for indicating the transmission timing difference.

Optionally, the first information is carried in radio resource control RRC signalling or a medium access control control element MAC CE.

Optionally, the first information includes: a downlink transmit time of the first TRP and a downlink transmit time of the second TRP; and/or a difference between a downlink transmit time of the first TRP and a downlink transmit time of the second TRP.

Optionally, the terminal device 1900 further includes a transmitting module, configured to transmit second information to the network device, where the second information is used for indicating the downlink time difference of arrival.

Optionally, in a case that the first TRP and the second TRP belong to different cells, the second information is further used for indicating a cell corresponding to the second TRP.

Optionally, the downlink time difference of arrival is determined based on measurement on a first downlink reference signal and a second downlink reference signal. The first downlink reference signal corresponds to the first TRP, and the second downlink reference signal corresponds to the second TRP.

Optionally, both the first TRP and the first downlink reference signal are associated with a first group of control resource sets CORESETs; and both the second TRP and the second downlink reference signal are associated with a second group of CORESETs.

Optionally, the first downlink reference signal and the second downlink reference signal each are one of the following reference signals: a synchronization signal block SSB or a channel state information reference signal CSI-RS.

Optionally, the terminal device 1900 further includes a reset module, configured to reset a first timer, where the first timer is used for maintaining validity of uplink synchronization information for the second TRP.

Optionally, the uplink synchronization information includes one or more of the following information: TA or a delay for unidirectional transmission.

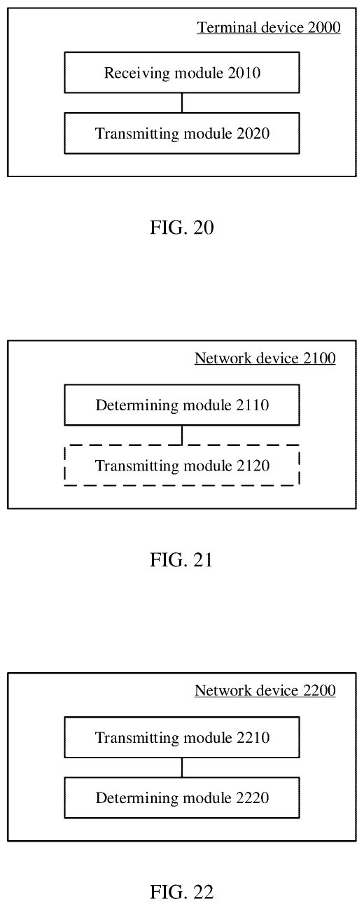

FIG. 20 is a schematic structural diagram of a terminal device according to another embodiment of this application. The terminal device 2000 shown in FIG. 20 may include a receiving module 2010 and a transmitting module 2020.

The receiving module 2010 may be configured to: when the terminal device is being in uplink synchronization with a first transmission-reception point TRP, receive first information, where the first information is used for activating a second TRP located in a different cell from the first TRP.

The transmitting module 2020 may be configured to: in response to the first information, transmit an uplink reference signal to the second TRP, where the uplink reference signal is used by a network device to determine uplink synchronization information for the second TRP.

Optionally, the first information is determined based on measurement performed by the terminal device on a downlink reference signal of the second TRP, and a transmit beam of the uplink reference signal corresponds to a receive beam of the downlink reference signal.

Optionally, a transmit time of the uplink reference signal is determined based on a receive time of the downlink reference signal.

Optionally, the first information is a unified transmission configuration indication TCI state.

Optionally, the uplink synchronization information includes one or more of the following information: timing advance TA or a delay for unidirectional transmission.

Optionally, the uplink reference signal is an aperiodic channel sounding reference signal SRS.

FIG. 21 is a schematic structural diagram of a network device according to an embodiment of this application. The network device 2100 shown in FIG. 21 may include a determining module 2110.

The determining module 2110 may be configured to: when the terminal device is being in uplink synchronization with a first transmission-reception point TRP, determine uplink synchronization information for a second TRP. The uplink synchronization information for the second TRP is determined based on one or more of the following information: uplink synchronization information for the first TRP; a downlink time difference of arrival, where the downlink time difference of arrival is used for indicating a difference between a time at which a signal of the first TRP arrives at the terminal device and a time at which a signal of the second TRP arrives at the terminal device; or a transmission timing difference between the first TRP and the second TRP.

Optionally, the uplink synchronization information for the second TRP is determined based on the uplink synchronization information for the first TRP, the downlink time difference of arrival, and the transmission timing difference.

Optionally, the uplink synchronization information for the first TRP is a delay for unidirectional transmission from the first TRP to the terminal device, the uplink synchronization information for the second TRP is timing advance TA corresponding to the second TRP, and the TA corresponding to the second TRP is twice a target value. The target value is equal to a sum of the downlink time difference of arrival and a difference between the delay for unidirectional transmission and the transmission timing difference.

Optionally, the network device 2100 further includes a transmitting module 2120. The transmitting module 2120 may be configured to transmit first information to the terminal device, where the first information is used for indicating the transmission timing difference.

Optionally, the first information is carried in radio resource control RRC signalling or a medium access control control element MAC CE.

Optionally, the first information includes: a downlink transmit time of the first TRP and a downlink transmit time of the second TRP; and/or a difference between a downlink transmit time of the first TRP and a downlink transmit time of the second TRP.

Optionally, the network device 2100 further includes a receiving module, configured to receive second information transmitted by the terminal device, where the second information is used for indicating the downlink time difference of arrival.

Optionally, in a case that the first TRP and the second TRP belong to different cells, the second information is further used for indicating a cell corresponding to the second TRP.

Optionally, the downlink time difference of arrival is determined based on measurement on a first downlink reference signal and a second downlink reference signal. The first downlink reference signal corresponds to the first TRP, and the second downlink reference signal corresponds to the second TRP.

Optionally, both the first TRP and the first downlink reference signal are associated with a first group of control resource sets CORESETs; and both the second TRP and the second downlink reference signal are associated with a second group of CORESETs.

Optionally, the first downlink reference signal and the second downlink reference signal each are one of the following reference signals: a synchronization signal block SSB or a channel state information reference signal CSI-RS.

Optionally, the uplink synchronization information includes one or more of the following information: TA or a delay for unidirectional transmission.

FIG. 22 is a schematic structural diagram of a network device according to another embodiment of this application. A network device 2200 shown in FIG. 22 may include a transmitting module 2210 and a determining module 2220.

The transmitting module 2210 may be configured to: when a terminal device is being in uplink synchronization with a first transmission-reception point TRP, transmit first information to the terminal device, where the first information is used for activating a second TRP located in a different cell from the first TRP.

The determining module 2220 may be configured to determine uplink synchronization information for the second TRP, where the uplink synchronization information is determined based on an uplink reference signal transmitted by the terminal device to the second TRP.

Optionally, the first information is determined based on measurement performed by the terminal device on a downlink reference signal of the second TRP, and a transmit beam of the uplink reference signal corresponds to a receive beam of the downlink reference signal.

Optionally, a transmit time of the uplink reference signal is determined based on a receive time of the downlink reference signal.

Optionally, the first information is a unified transmission configuration indication TCI state.

Optionally, the uplink synchronization information includes one or more of the following information: timing advance TA or a delay for unidirectional transmission.

Optionally, the uplink reference signal is an aperiodic channel sounding reference signal SRS.

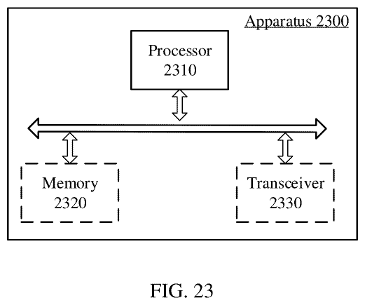

FIG. 23 is a schematic diagram of a structure of a communications apparatus according to an embodiment of this application. A dashed line in FIG. 23 indicates that the unit or module is optional. The apparatus 2300 may be configured to implement the method described in the foregoing method embodiments. The apparatus 2300 may be a chip, a terminal device, or a network device.

The apparatus 2300 may include one or more processors 2310. The processor 2310 may support the apparatus 2300 to implement the method described in the foregoing method embodiments. The processor 2310 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 2300 may further include one or more memories 2320. The memory 1820 stores a program, and the program may be executed by the processor 2310, so that the processor 2310 executes the method described in the foregoing method embodiments. The memory 2320 may be independent of or integrated into the processor 2310.

The apparatus 2300 may further include a transceiver 2330. The processor 2310 may communicate with another device or chip by using the transceiver 2330. For example, the processor 2310 may transmit and receive data to and from another device or chip by using the transceiver 2330.

An embodiment of this application further provides a computer-readable storage medium for storing a program. The computer-readable storage medium may be applied to the terminal or the network device provided in embodiments of this application, and the program causes a computer to execute the methods performed by the terminal or the network device in various embodiments of this application.

An embodiment of this application further provides a computer program product. The computer program product includes a program. The computer program product may be applied to the terminal or the network device provided in embodiments of this application, and the program causes a computer to execute the methods performed by the terminal or the network device in various embodiments of this application.

An embodiment of this application further provides a computer program. The computer program may be applied to the terminal or the network device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are only used to explain the specific embodiments of this application, and are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of the application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, the “predefining” and “pre-configuration” may be implemented by pre-storing a corresponding code or table in a device (for example, the terminal device and the access network device) or in other manners that may be used for indicating related information, and a specific implementation thereof is not limited in this application. For example, being pre-defined may refer to being defined in a protocol.

In embodiments of this application, the “protocol” may refer to a standard protocol in the communications field, and may include, for example, an LTE protocol, an NR protocol, and a related protocol applied to a future communications system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of the embodiments of this application.

In the several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interface, apparatuses or units, and may be implemented in electrical, mechanical, or other forms

Units described as separate components may be or may not be physically separate, and components displayed as units may be or may not be physical units, that is, may be located in one place or distributed among a plurality of network units. Some or all of the units may be selected according to actual needs to achieve the objective of the solutions of the embodiments.

In addition, functional units in embodiments of this application may be integrated into one processing unit, or each of the units may exist alone physically, or two or more units may be integrated into one unit.

All or some of the foregoing embodiments may be implemented by software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An apparatus, wherein the apparatus is a terminal device and comprises a processor configured to invoke a program from a memory, to cause the apparatus to execute:
when theterminal device is being in uplink synchronization with a first transmission-reception point (TRP), determining uplink synchronization information for a second TRP,
wherein the uplink synchronization information for the second TRP is determined based on one or more of following information:
uplink synchronization information for the first TRP;
a downlink time difference of arrival, wherein the downlink time difference of arrival is used for indicating a difference between a time at which a signal of the first TRP arrives at the terminal device and a time at which a signal of the second TRP arrives at the terminal device; or
a transmission timing difference between the first TRP and the second TRP.

2. The apparatus according to claim 1, wherein the uplink synchronization information for the second TRP is determined based on the uplink synchronization information for the first TRP, the downlink time difference of arrival, and the transmission timing difference.

3. The apparatus according to claim 2, wherein the uplink synchronization information for the first TRP is a delay for unidirectional transmission from the first TRP to the terminal device, the uplink synchronization information for the second TRP is timing advance (TA) corresponding to the second TRP, and the TA corresponding to the second TRP is twice a target value, wherein the target value is equal to a sum of the downlink time difference of arrival and a difference between the delay for unidirectional transmission and the transmission timing difference.

4. The apparatus according to claim 1, wherein before the determining uplink synchronization information for a second TRP, the processor is configured to invoke the program to cause the apparatus to further execute:
receiving first information from a network device, wherein the first information is used for indicating the transmission timing difference.

5. The apparatus according to claim 4, wherein the first information is carried in radio resource control (RRC) signalling or a medium access control control element (MAC CE).

6. The apparatus according to claim 4, wherein the first information comprises:
a downlink transmit time of the first TRP and a downlink transmit time of the second TRP; and/or
a difference between a downlink transmit time of the first TRP and a downlink transmit time of the second TRP.

7. The apparatus according to claim 1, wherein before the determining uplink synchronization information for a second TRP, the the processor is configured to invoke the program to cause the apparatus to further execute:
transmitting second information to a network device, wherein the second information is used for indicating the downlink time difference of arrival.

8. The apparatus according to claim 7, wherein in a case that the first TRP and the second TRP belong to different cells, the second information is further used for indicating a cell corresponding to the second TRP.

9. The apparatus according to claim 1, wherein the downlink time difference of arrival is determined based on measurement on a first downlink reference signal and a second downlink reference signal, the first downlink reference signal corresponds to the first TRP, and the second downlink reference signal corresponds to the second TRP.

10. The apparatus according to claim 9, wherein the first downlink reference signal and the second downlink reference signal each are one of following reference signals: a synchronization signal block (SSB) or a channel state information reference signal (CSI-RS).

11. An apparatus, wherein the apparatus is a network device and comprises a processor configured to invoke a program from a memory, to cause the apparatus to execute:
when a terminal device is being in uplink synchronization with a first transmission-reception point (TRP), determining uplink synchronization information for a second TRP,
wherein the uplink synchronization information for the second TRP is determined based on one or more of following information:
uplink synchronization information for the first TRP;
a downlink time difference of arrival, wherein the downlink time difference of arrival is used for indicating a difference between a time at which a signal of the first TRP arrives at the terminal device and a time at which a signal of the second TRP arrives at the terminal device; or
a transmission timing difference between the first TRP and the second TRP.

12. The apparatus according to claim 11, wherein the uplink synchronization information for the second TRP is determined based on the uplink synchronization information for the first TRP, the downlink time difference of arrival, and the transmission timing difference.

13. The apparatus according to claim 12, wherein the uplink synchronization information for the first TRP is a delay for unidirectional transmission from the first TRP to the terminal device, the uplink synchronization information for the second TRP is timing advance (TA) corresponding to the second TRP, and the TA corresponding to the second TRP is twice a target value, wherein the target value is equal to a sum of the downlink time difference of arrival and a difference between the delay for unidirectional transmission and the transmission timing difference.

14. The apparatus according to claim 11, wherein before the determining uplink synchronization information for a second TRP, the processor is configured to invoke the program to cause the apparatus to further execute:
transmitting first information to the terminal device, wherein the first information is used for indicating the transmission timing difference.

15. The apparatus according to claim 14, wherein the first information is carried in radio resource control (RRC) signalling or a medium access control control element (MAC CE).

16. The apparatus according to claim 14, wherein the first information comprises:
a downlink transmit time of the first TRP and a downlink transmit time of the second TRP; and/or
a difference between a downlink transmit time of the first TRP and a downlink transmit time of the second TRP.

17. The apparatus according to claim 11, wherein before the determining uplink synchronization information for a second TRP, the processor is configured to invoke the program to cause the apparatus to further execute:
receiving second information transmitted by the terminal device, wherein the second information is used for indicating the downlink time difference of arrival.

18. The apparatus according to claim 17, wherein in a case that the first TRP and the second TRP belong to different cells, the second information is further used for indicating a cell corresponding to the second TRP.

19. The apparatus according to claim 11, wherein the downlink time difference of arrival is determined based on measurement on a first downlink reference signal and a second downlink reference signal, the first downlink reference signal corresponds to the first TRP, and the second downlink reference signal corresponds to the second TRP.

20. The apparatus according to claim 19, wherein the first downlink reference signal and the second downlink reference signal each are one of following reference signals: a synchronization signal block (SSB) or a channel state information reference signal (CSI-RS).
